(19) United States
(12) Patent Application Publication
(10) Pub. No.: US 2023/0142772 A1
(43) Pub. Date: May 11, 2023

(54) SIDE LOBE LEVEL ENHANCEMENT IN AN ARRAY ANTENNA

(71) Applicant: Telefonaktiebolaget LM Ericsson (publ), Stockholm (SE)

(72) Inventors: Stefan JOHANSSON, Romelanda (SE); Henrik JIDHAGE, Hovås (SE)

(73) Assignee: Telefonaktiebolaget LM Ericsson (publ), Stockholm (SE)

(21) Appl. No.: 17/912,128

(22) PCT Filed: Mar. 18, 2020
(86) PCT No.: PCT/SE2020/050288

§ 371 Date: Sep. 16, 2022

(51) Int. Cl. H01Q 3/36

(52) U.S. Cl. CPC H01Q 3/36; H04B 7/0617

(57) ABSTRACT

The present disclosure relates to an array antenna arrangement comprising at least one set of at least two sub-array antennas. Each set of sub-array antennas is mounted such that a corresponding array antenna column is formed. For each polarization in each set of sub-array antennas, each sub-array antenna comprises a corresponding sub-array antenna port that is associated with a certain sub-array antenna beam pointing direction setting, and each sub-array antenna port is connected to a corresponding radio chain in a set of radio chains, where each set of radio chains is adapted to provide a corresponding digital antenna beam pointing direction setting. In at least one set of sub-array antennas, at least one sub-array beam pointing direction setting, differs from a corresponding digital antenna beam pointing direction setting.

### TECHNICAL FIELD

The present disclosure relates to an array antenna arrangement comprising at least one set of at least two sub-array antennas, where each set of sub-array antennas is mounted such that a corresponding array antenna column is formed.

### BACKGROUND

An AAS (Active Antenna System) for mobile cellular communication networks is normally required to have a broad primary coverage angular range in the horizontal plane, while in the vertical plane, the primary coverage angular range is significantly smaller. Desired vertical angular range for the primary coverage depends on cell size, height position of the AAS, user distribution, path loss, etc. Therefore, an AAS typically consists of an array of vertical sub-arrays, in order to optimize the array aperture and number of radio chains with respect to the desired primary coverage angular range. The primary coverage angular range is here defined as the angular range where the AAS is to ensure high antenna gain and by that high EIRP (Effective Isotropic Radiated Power) and EIS (Effective Isotropic Sensitivity).

An example of an AAS product comprises 32 radio chains feeding an array of vertical sub-arrays in a 2 row times 8 column configuration. To obtain high antenna gain given the few radio chains, the vertical sub-arrays needs to be quite large, for example 6-element sub-arrays. Since there are only two rows in that case, the beamforming capability in the vertical plane will be somewhat limited, but, for instance, there are room for some digital tilt in the vertical plane.

However, the large sub-arrays will give sub-array radiation patterns with quite narrow vertical beamwidths. This cannot be compensated for by the offered digital tilt and thus the primary vertical coverage angular range of the AAS also becomes quite narrow.

To partly overcome this limitation, phase-shifters can be added within the sub-arrays allowing for semi-static electrical tilt setting of the sub-arrays. These can typically consist of electro-mechanically controlled phase shifters composed of movable parts accomplishing true-time delay phase shifting. The analog tilt setting can be used to semi-statically adjust the vertical coverage angular range to the conditions valid at the specific installation etc.

To reduce interference, it is important that the radiation above the vertical coverage angular range can be minimized. I.e. it is beneficial with low upper side lobe levels in the vertical plane. For broadcast beams it is also crucial with low side lobe levels to reduce the risk of selecting wrong UE's to the cell. Typical, requirements can be that the first upper side lobe level should be <−15 dB, but in some cases even lower side lobe levels are requested depending on the radio network situation at the specific site.

Desired vertical side lobe level can be accomplished by having an amplitude and/or phase taper over the excitations of the antenna elements in the vertical plane. However, suppressing the side lobe levels normally comes with a price of reduced antenna gain and if done digitally also by reduced utilization of the radio power resources (in case of amplitude taper).

For the example above, amplitude and/or phase taper has to be accomplished in the hardware design since there are only two rows in the antenna array. This means that for an AAS structure of the described type, the side lobe suppression will be given by the hardware design and cannot be digitally adjusted by the digital weight factors exciting the sub-arrays.

There is thus a need for an improved beamforming capability in the vertical plane for an AAS where reduced side lobe levels are obtained.

### SUMMARY

It is an object of the present disclosure to provide improved beamforming capability in the vertical plane for an array antenna, such as an AAS, where reduced side lobe levels are obtained.

Said object is obtained by means of an array antenna arrangement comprising at least one set of at least two sub-array antennas, where each set of sub-array antennas is mounted such that a corresponding array antenna column is formed. For each polarization in each of sub-array antennas each sub-array antenna comprises a corresponding sub-array antenna port that is associated with a certain sub-array antenna beam pointing direction setting, and each sub-array antenna port is connected to a corresponding radio chain in a set of radio chains. Each set of radio chains is adapted to provide a corresponding digital antenna beam pointing direction setting. In at least one set of sub-array antennas, at least one sub-array beam pointing direction setting differs from a corresponding digital antenna beam pointing direction setting.

This provides side lobe level enhancements and reconfigurability by means of software control for an array antenna, such as an AAS.

According to some aspects, each sub-array antenna comprises at least two sub sub-arrays having one or two common polarizations, each sub sub-array comprising at least one antenna element.

This means that there can be two or more rows of sub-array antennas in the array antenna arrangement. The array antenna arrangement can either be adapted for only a single polarization or two polarizations that according to some aspects are mutually orthogonal.

According to some aspects, each sub-array antenna beam pointing direction setting is obtained by means of at least one controllable phase shifter for each sub-array antenna port.

In this way, a variable sub-array antenna beam pointing direction setting is obtained.

According to some aspects, each sub-array antenna beam pointing direction setting is obtained by means of fixed predetermined phase shifts.

In this way, a sub-array antenna beam pointing direction setting is obtained in an uncomplicated and reliable manner.

According to some aspects, the sub-array antenna beam pointing direction settings are the same for the sub-array antenna ports of at least one set of sub-array antennas.

According to some aspects, the sub-array antenna beam pointing direction settings are mutually different for the sub-array antenna ports of at least one set of sub-array antennas.

This means that the sub-array antenna beam pointing direction settings either can be the same and/or different for the sub-array antenna ports of least one array antenna column in the array antenna arrangement. As a consequence, one or more antenna columns can have sub-array antenna ports with the same sub-array antenna beam pointing direction settings, and one or more other antenna columns can have antenna ports with mutually different sub-array antenna beam pointing direction settings. It is also possible that all sub-array antenna ports of all array antenna column in the array antenna arrangement either have the same sub-array antenna beam pointing direction settings or mutually different sub-array antenna beam pointing direction settings. This provides versatility.

According to some aspects, the digital antenna beam pointing direction settings are the same for those sets of radio chains that are connected to the sub-array antenna ports of at least one set of sub-array antennas.

According to some aspects, the digital antenna beam pointing direction settings are mutually different for those sets of radio chains that are connected to the sub-array antenna ports of at least one set of sub-array antennas.

This means that the digital antenna beam pointing direction settings either are the same and/or different for the sub-array antenna ports of least one array antenna column in the array antenna arrangement. As a consequence, one or more antenna columns can have sub-array antenna ports with the same digital antenna beam pointing direction settings, and one or more other antenna columns can have antenna ports with mutually different digital antenna beam pointing direction settings. It is also possible that all sub-array antenna ports of all array antenna column in the array antenna arrangement either have the same digital antenna beam pointing direction settings or mutually different digital antenna beam pointing direction settings. This provides versatility.

This object is also obtained by means of methods that are associated with the above advantages.

### BRIEF DESCRIPTION OF THE DRAWINGS

The present disclosure will now be described more in detail with reference to the appended drawings, where:

FIG. 1 shows a schematic front view of an array antenna;

FIG. 2 shows a schematic front view of a sub-array antenna;

FIG. 3a-c show predicted vertical radiation patterns for a first example of a broadcast beam;

FIG. 4a-c show predicted vertical radiation patterns for a second example of a broadcast beam;

FIG. 5a-c show predicted vertical radiation patterns for a third example of a broadcast beam; and

FIG. 6 shows a flowchart for methods according to the present disclosure.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

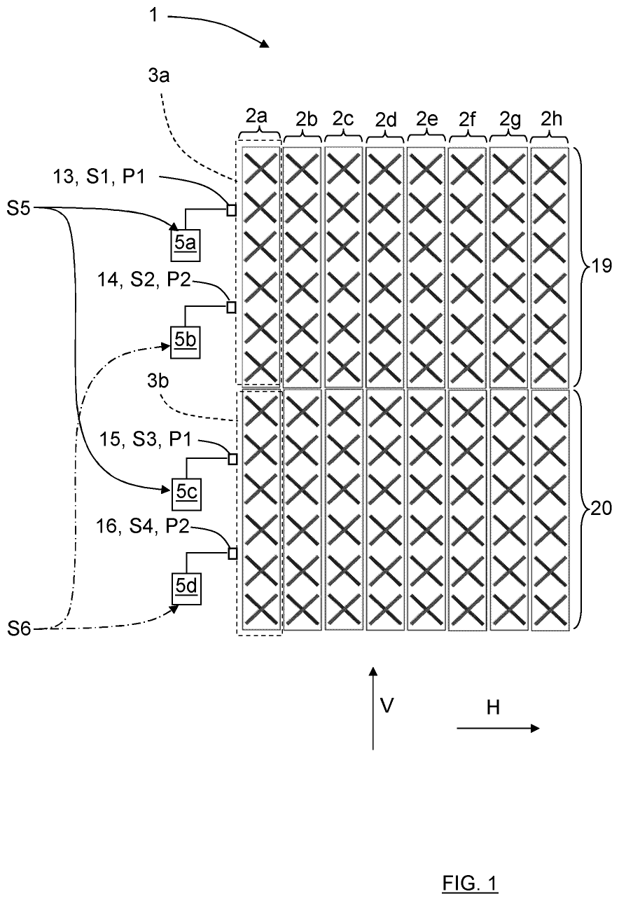

As shown in FIG. 1, there is an array antenna arrangement 1 comprising eight sets 2a, 2b, 2c, 2d, 2e, 2f, 2g, 2h of sub-array antennas that comprises two sub-array antennas 3a, 3b each. For reasons of clarity in FIG. 1, only a first set 2a of sub-array antennas has the corresponding two sub-array antennas 3a, 3b indicated. For the same reason, only those ports and components that are associated with these two sub-array antennas 3a, 3b are indicated in FIG. 1. It should be understood that each set 2a, 2b, 2c, 2d, 2e, 2f, 2g, 2h of sub-array antennas comprises two corresponding sub-array antennas with associated ports and components.

Each set 2a, 2b, 2c, 2d, 2e, 2f, 2g, 2h of sub-array antennas is mounted such that a corresponding array antenna column is formed, here a vertical linear array antenna column, extending along a vertical extension V. According to some aspects, as shown for this example, the sets 2a, 2b, 2c, 2d, 2e, 2f, 2g, 2h of sub-array antennas is mounted such that they extend along a horizontal extension H. According to some aspects, each array antenna column formed can extend in any direction, and the antenna elements can be mutually offset in a constant or interleaving manner such that either a tilted antenna column or a straight and broaden antenna column is obtained.

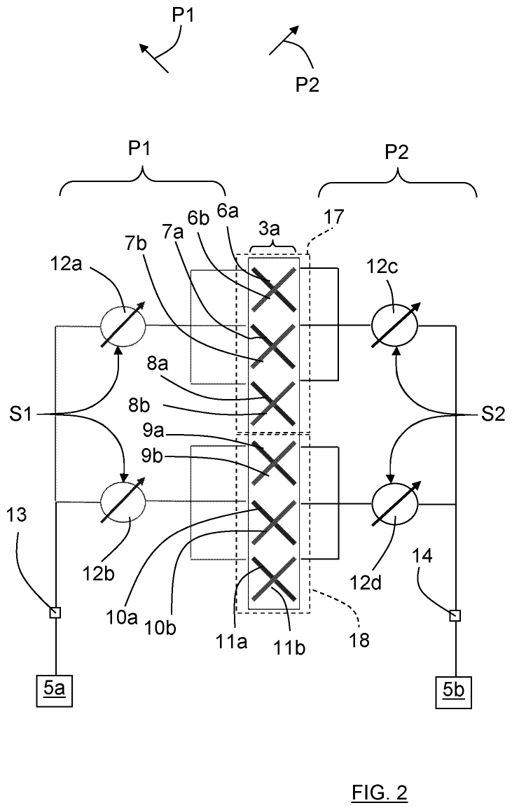

With reference also to FIG. 2, in the following, the first set 2a of sub-array antennas will be discussed, and it will be understood that the discussed features are applicable for all sets 2a, 2b, 2c, 2d, 2e, 2f, 2g, 2h of sub-array antennas. The first set 2a of sub-array antennas comprises a first sub-array antenna 3a and a second sub-array antenna 3b, where the first sub-array antenna 3a is comprised in a first row 19 of sub-array antennas, and the second sub-array antenna 3b is comprised in a second row 20 of sub-array antennas in the array antenna arrangement 1.

The first sub-array antenna 3a is shown in detail in FIG. 2. The first sub-array antenna 3a comprises a first antenna element 6a, a second antenna element 7a, a third antenna element 8a, a fourth antenna element 9a, a fifth antenna element 10a and a sixth antenna element of a first polarization P1, and a first antenna element 6b, a second antenna element 7b, a third antenna element 8b, a fourth antenna element 9b, a fifth antenna element 10b and a sixth antenna element 11b of a second polarization P2. The first antenna elements 6a, 6b, the second antenna elements 7a, 7b, the third antenna elements 8a, 8b, the fourth antenna elements 9a, 9b, the fifth antenna elements 10a, 10b and the sixth antenna elements 11a, 11b form corresponding dual polarized antenna elements 6a, 6b; 7a, 7b; 8a, 8b, 9a, 9b; 10a 10b; 11a, 11b. The polarizations P1, P2 are according to some aspects mutually orthogonal and are here, as an example, shown slanted ±45°.

The first dual polarized antenna element 6a, 6b, second dual polarized antenna element 7a, 7b and third dual polarized antenna element 8a, 8b are comprised in a first sub sub-array 17, and the fourth dual polarized antenna element 9a, 9b, the fifth dual polarized antenna element 10a, 10b and the sixth dual polarized antenna element 11a, 11b are comprised in a second sub sub-array 18.

For each polarization P1, P2, each sub-array antenna 3a, 3b comprises a corresponding sub-array antenna port 13, 15; 14, 16 that is associated with a certain sub-array antenna beam pointing direction setting S1, S2, S3, S4. Each sub-array antenna port 13, 15; 14, 16 is connected to a corresponding radio chain 5a, 5c; 5b, 5d in a set of radio chains 5a, 5c; 5b, 5d. Each set of radio chains 5a, 5c; 5b, 5d is adapted to provide a corresponding digital antenna beam pointing direction setting S5, S6. According to some aspects, the antenna beam pointing direction settings S1, S2, S3, S4, S5, S6 relates to an antenna beam pointing direction in a vertical plane, extending along the vertical extension V. This can be referred to as a vertical antenna beam pointing direction.

As shown in FIG. 2, for the first polarization P1, the first sub-array antenna 3a comprises a first controllable phase shifter 12a connected to the first antenna element 6a, the second antenna element 7a, and the third antenna element 8a of the first polarization P1, and a second controllable phase shifter 12b connected to the fourth antenna element 9a, the fifth antenna element 10a and the sixth antenna element 11a of the first polarization P1. This means that the first controllable phase shifter 12a is connected to the antenna elements of the first polarization P1 in the first sub sub-array 17, and the second controllable phase shifter 12b is connected to the antenna elements of the first polarization P1 in the second sub sub-array 18.

Correspondingly, for the second polarization P2, the first sub-array antenna 3a comprises a third controllable phase shifter 12c connected to the first antenna element 6b, the second antenna element 7b, and the third antenna element 8b of the second polarization P2, and a fourth controllable phase shifter 12d connected to the fourth antenna element 9b, the fifth antenna element 10b and the sixth antenna element 11b of the second polarization P2. This means that the third controllable phase shifter 12c is connected to the antenna elements of the second polarization P2 in the first sub sub-array 17, and the fourth controllable phase shifter 12d is connected to the antenna elements of the second polarization P2 in the second sub sub-array 18.

Furthermore, the first controllable phase shifter 12a and the second controllable phase shifter 12b are combined to a first sub-array antenna port 13, which further is connected to a first radio chain 5a. Correspondingly, the third controllable phase shifter 12c and the fourth controllable phase shifter 12d are combined to a second sub-array antenna port 14, which further is connected to a second radio chain 5b.

A corresponding arrangement is applied for the second sub-array antenna 3b that comprises a third sub-array antenna port 15 which is connected to a third radio chain 5c, and a fourth sub-array antenna port 16 which is connected to a fourth radio chain 5d.

With reference to both FIG. 1 and FIG. 2, by having a certain setting of the first controllable phase shifter 12a and the second controllable phase shifter 12b, a resulting first sub-array antenna beam pointing direction setting S1 is obtained at the first sub-array antenna port 13, and by having a certain setting of the third controllable phase shifter 12c and the fourth controllable phase shifter 12d, a resulting second sub-array antenna beam pointing direction setting S2 is obtained at the second sub-array antenna port 14.

In the same manner, a third sub-array antenna beam pointing direction setting S3 is obtained at the third sub-array antenna port 15, and a fourth sub-array antenna beam pointing direction setting S4 is obtained at the fourth sub-array antenna port 16.

Furthermore, with reference to FIG. 1, by setting certain digital weight factors at the first radio chain 5a and the third radio chain 5c, a first digital antenna beam pointing direction setting S5 is obtained for the first polarization P1, and by setting certain digital weight factors at the second radio chain 5b and the fourth radio chain 5d, a second digital antenna beam pointing direction setting S6 is obtained for the second polarization P2.

In this manner, for the array antenna arrangement 1 according to the present example, 32 sub-array antenna ports and 32 radio chains are provided, where each group of 16 sub-array antenna ports and 16 corresponding radio chains is associated with one common polarization P1, P2.

According to the present disclosure, in at least one set 2a, 2b, 2c, 2d, 2e, 2f, 2g, 2h of sub-array antennas 3a, 3b, at least one sub-array beam pointing direction setting S1, S3; S2, S4, differs from a corresponding digital antenna beam pointing direction setting S5, S6.

This means that, for example, a vertical digital antenna beam pointing direction setting for all sets 2a, 2b, 2c, 2d, 2e, 2f, 2g, 2h of sub-array antennas can be the same and set to 7°, and a vertical sub-array antenna beam pointing direction setting for all sets 2a, 2b, 2c, 2d, 2e, 2f, 2g, 2h of sub-array antennas can be the same and set to another value.

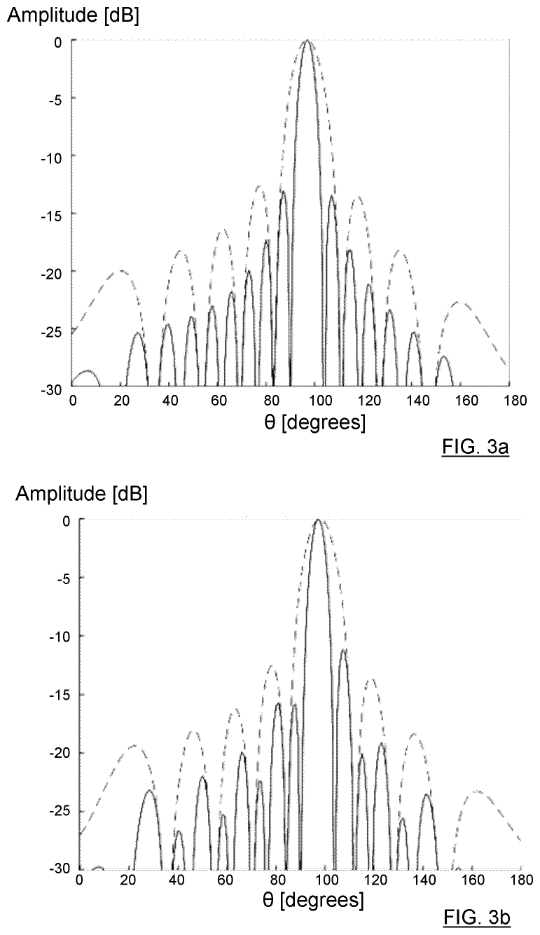

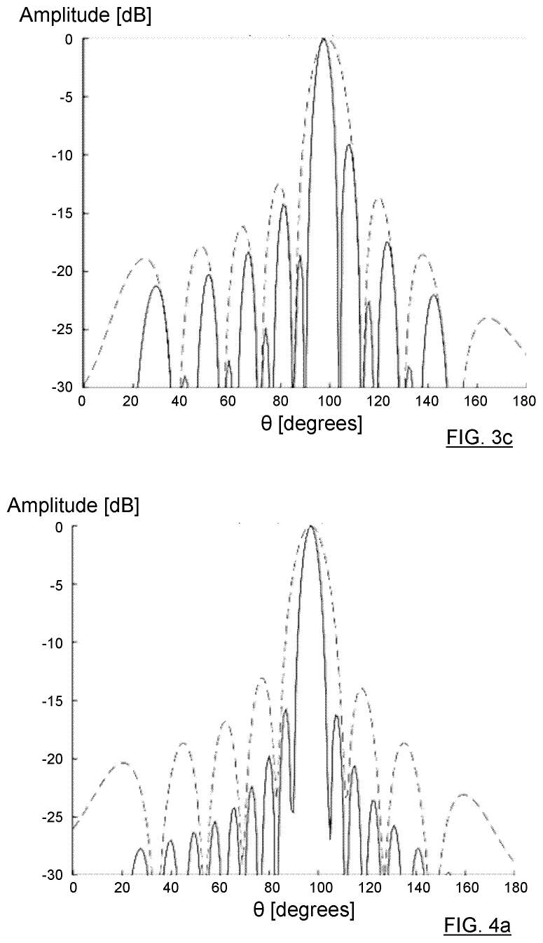

Illustrated examples will be discussed in the following, where the antenna beam pointing direction is in the vertical plane. FIG. 3a-FIG. 3c show predicted vertical radiation patterns for a first example. Solid lines indicate predicted vertical radiation patterns for broadcast beam with a desired beam pointing direction θ_{D}=7°, and dashed lines indicate vertical radiation patterns of the sub-arrays.

In FIG. 3a, showing a vertical radiation pattern reference case that does not take advantage of the present disclosure, the digital antenna beam pointing direction setting corresponds to θ_{dig}=7° and the sub-array antenna beam pointing direction setting corresponds to θ_{sub}=7°. It is assumed that there is no amplitude taper over the antenna element excitations in the vertical plane and thus the upper side lobe suppression is 13 dB. The angles mentioned here and below are constituted by tilt angles which correspond to antenna beam pointing direction settings.

FIG. 3b shows the vertical radiation pattern when the digital antenna beam pointing direction setting still corresponds to θ_{dig}=7° and the sub-array antenna beam pointing direction setting corresponds to θ_{sub}=8°, i.e. with 1° over-tilt. The main beam is still pointing at θ_{D}=7°, but the resulting upper side lobe suppression is now 15.8 dB, a 2.8 dB improvement compared to the reference case in FIG. 3a. The drop in peak gain drop is <0.1 dB compared to the peak gain for the reference case in FIG. 3a.

FIG. 3c shows that the sidelobe suppression can be increased with even more increased tilt to the expense of a slight reduction in gain. The digital antenna beam pointing direction setting still corresponds to θ_{dig}=7° and the sub-array antenna beam pointing direction setting corresponds to θ_{sub}=9°, i.e. with 2° over-tilt. The main beam is still pointing at θ_{D}=7° but the resulting upper side lobe suppression is now 18.6 dB, a 5.6 dB improvement compared to the reference case in FIG. 3a. The peak gain drop is <0.3 dB compared to the peak gain for the reference case in FIG. 3a.

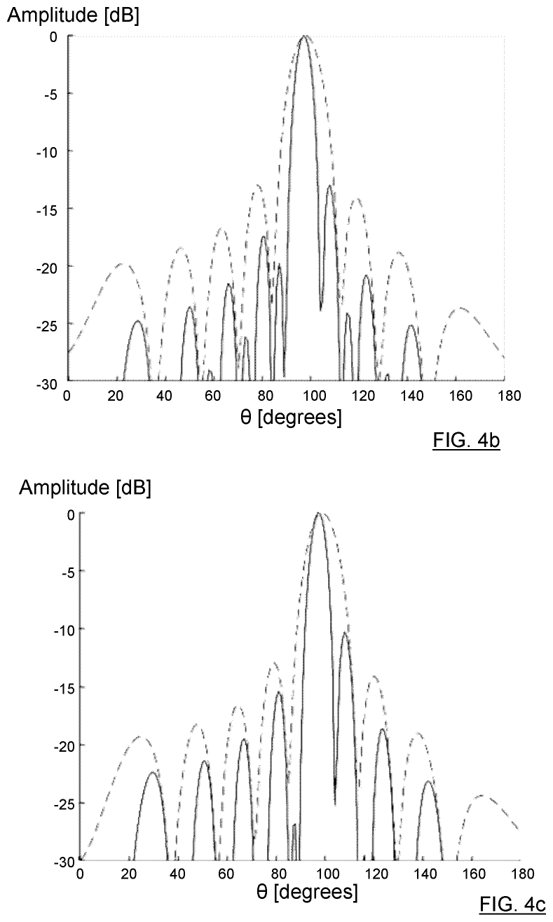

The FIGS. 4a-4c illustrate a second example that mainly corresponds to the first example, except that a cosine amplitude taper has been added over the antenna element excitations in the vertical plane giving a sidelobe suppression of 15.7 dB. That is, the upper and the lower vertical 6-element sub-arrays are designed to have antenna element excitations such that the antenna element excitations over the full 12 elements has a cosine amplitude taper that gives 15.7 dB sidelobe suppression. Solid lines indicate predicted vertical radiation patterns for broadcast beam with a desired beam pointing direction θ_{D}=7°, and dashed lines indicate vertical radiation patterns of the sub-arrays.

FIG. 4a shows the predicted vertical radiation pattern for this case that is a reference case that does not take advantage of the present disclosure. The digital antenna beam pointing direction setting corresponds to θ_{dig}=7° and the sub-array antenna beam pointing direction setting corresponds to θ_{sub}=7°.

FIG. 4b shows the vertical radiation pattern when the digital antenna beam pointing direction setting still corresponds to θ_{dig}=7° and the sub-array antenna beam pointing direction setting corresponds to θ_{sub}=8°, i.e. with 1° over-tilt. The resulting upper side lobe suppression has now increased to 19.8 dB, a 4.1 dB improvement compared to the reference case in FIG. 4a. The peak gain drop is <0.1 dB compared to the peak gain for the reference case in FIG. 4a.

FIG. 4c shows the vertical radiation pattern when the digital antenna beam pointing direction setting still corresponds to θ_{dig}=7° and the sub-array antenna beam pointing direction setting corresponds to θ_{sub}=9°, i.e. with 2° over-tilt. The resulting upper side lobe suppression has now increased to 26.9 dB, an 11.2 dB improvement compared to the reference case in FIG. 4a. The peak gain drop is <0.3 dB compared to the peak gain for the reference case in FIG. 4a.

Table 1 below summarizes gain and upper side lobe suppression (USLS) for the examples above, “uniform” for the case without taper, “taper” for the tapered case and “subarray tilt” for sub-array antenna beam pointing direction setting in degrees.

| | |
|---|---|
| Uniform | Taper |

| Subarray tilt | Gain | 1st USLS | Gain | 1st USLS |
|---|---|---|---|---|
| 7 | 18.8 | 13.0 | 18.7 | 15.7 |
| 8 | 18.7 | 15.8 | 18.7 | 19.8 |
| 9 | 18.5 | 18.6 | 18.4 | 26.9 |

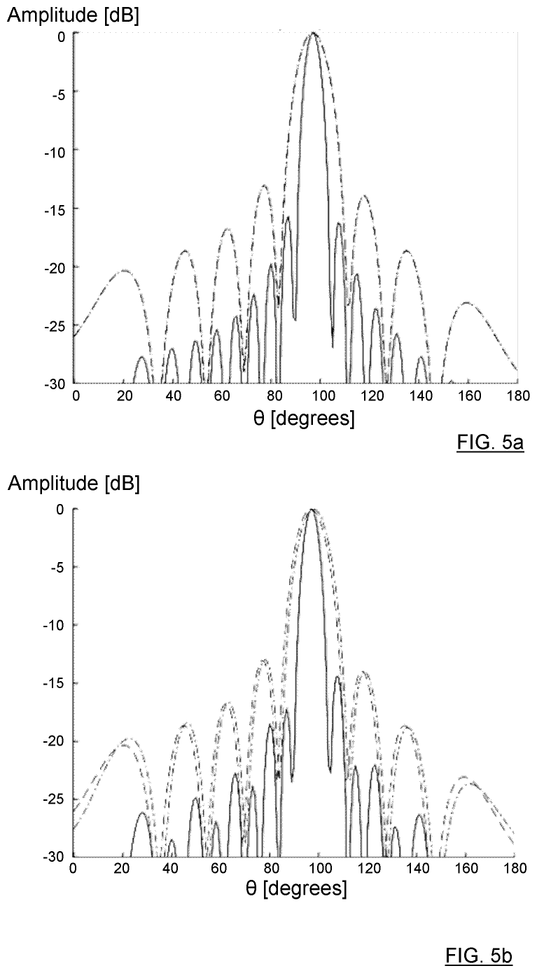

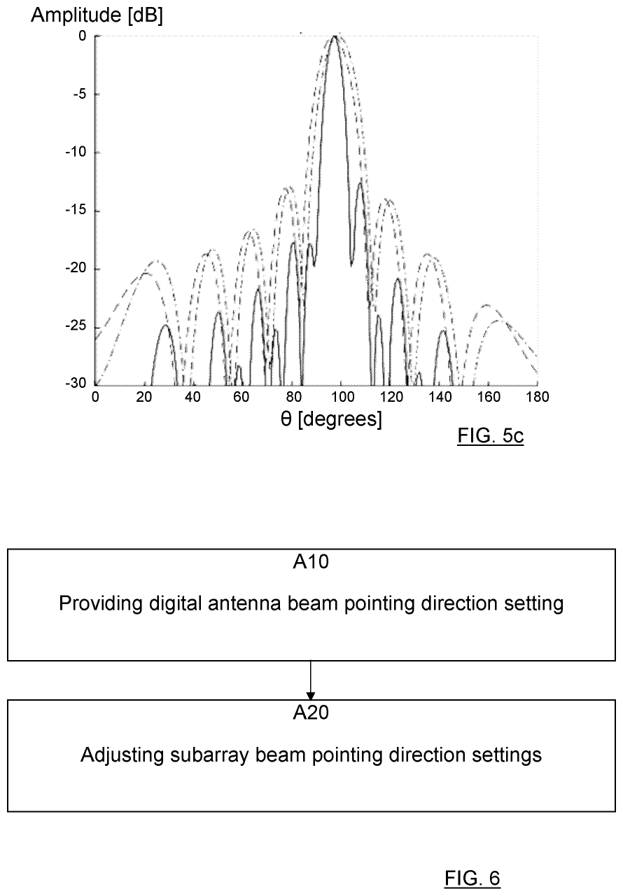

The FIGS. 5a-5c illustrate a third example that mainly corresponds to the second example, except that in this case it is assumed that the tilt setting of the sub-arrays in the two rows 19, 20 can be set differently. That is, the sub-arrays 3a in the first row 19 have a sub-array antenna beam pointing direction setting that corresponds to a tilt angle θ_{sub,upp} and the sub-arrays in the lower row have digital antenna beam pointing direction setting that corresponds to a tilt angle θ_{sub,low}. Solid lines indicate predicted vertical radiation patterns for broadcast beam with a desired beam pointing direction θ_{D}=7°, and dashed/dash-dotted lines indicate vertical radiation patterns of the first/second sub-arrays, respectively.

FIG. 5a shows a reference case that is the same as the case illustrated in FIG. 4a.

FIG. 5b shows the vertical radiation pattern when the digital antenna beam pointing direction setting corresponds to θ_{dig}=7° while the sub-array antenna beam pointing direction setting of the sub-arrays in the first row 19 is set to θ_{sub,upp}=8°, i.e. with 10 over-tilt, and the sub-array antenna beam pointing direction setting of the sub-arrays in the second row 20 is set to θ_{sub}=7°, i.e. no over-tilt.

FIG. 5c shows the vertical radiation pattern when the digital antenna beam pointing direction setting corresponds to θ_{dig}=7° while the sub-array antenna beam pointing direction setting of the sub-arrays in the first row 19 is set to θ_{sub,upp}=9°, i.e. with 2° over-tilt, and the array antenna beam pointing direction setting of the sub-arrays in the second row 20 is set to θ_{sub,low}=7°, i.e. no over-tilt.

Comparing the results in FIG. 4a-c and FIG. 5a-c it can be noticed that by having different antenna beam pointing direction settings between the sub-arrays in two rows 19, 20, also the second upper side lobe can, to some extent, be suppressed and controlled by the antenna beam pointing direction settings. Table 2 summarizes gain and upper first and second side lobe suppressions for the examples in FIG. 4a-c and FIG. 5a-c, the digital antenna beam pointing direction setting corresponds to the digital tilt angle θ_{dig}=7°.

| Sub-array tilt | Sub-array tilt | | | |
|---|---|---|---|---|
| first row | second row | Gain | 1^{st} USLS | 2^{nd} USLS |
| 7° | 7° | 18.7 | 15.7 | 19.8 |
| 7° | 8° | 18.7 | 17.2 | 18.5 |
| 8° | 8° | 18.7 | 19.8 | 17.5 |
| 7° | 9° | 18.6 | 17.8 | 17.7 |
| 9° | 9° | 18.4 | 26.9 | 15.4 |

It should be noted that, naturally, there are other alternatives when it comes to having pluralities of subarrays having different antenna beam pointing direction settings. For instance, in the example above there is two pluralities of sub-arrays with different sub-array antenna beam pointing direction setting, divided in a first plurality in the first row 19 and a second plurality in the second row 20. However, two or more pluralities with different sub-array antenna beam pointing direction settings can be distributed differently over the array antenna arrangement 1. Even different sub sub-arrays can have mutually different sub-array antenna beam pointing direction setting.

According to some aspects, the digital antenna beam pointing direction setting S5, S6 is adjusted for each sub-array antenna port 13, 15; 14, 16, and the thereafter the sub-array beam pointing direction settings S1, S2, S3, S4 associated with corresponding sub-array antenna ports 13, 14, 15, 16 are adjusted such that a desired vertical side lobe level is obtained for the array antenna arrangement 1.

According to some aspects, each sub-array antenna 3a, 3b comprises at least two sub sub-arrays 17, 18 having one or two common polarizations P1, P2, each sub sub-array 17, 18 comprising at least one antenna element 6a, 6b, 7a, 7b 8a, 8b; 9a, 9b, 10a, 10b, 11a; 11b.

This means that there can be two or more rows of sub-array antennas in the array antenna arrangement 1. The array antenna arrangement 1 can either be adapted for only a single polarization or two polarizations that according to some aspects are mutually orthogonal.

According to some aspects, each sub-array antenna beam pointing direction setting S1, S2; S3, S4 is obtained by means of at least one controllable phase shifter 12a, 12b, 12c, 12d for each sub-array antenna port 13, 14; 15, 16.

In the example shown with reference to FIG. 2 there are two controllable phase shifters 12a, 12b, 12c, 12d for each sub-array antenna port 13, 14; 15, 16, but is it conceivable that, for each polarization, only one of the branches leading from a sub sub-array is connected to a controllable phase shifter.

According to some aspects, each sub-array antenna beam pointing direction setting S1, S2; S3, S4 is obtained by means of fixed predetermined phase shifts.

In this case, no controllable phase shifters are used. A combination of controllable phase shifters and fixed predetermined phase shifts is also conceivable. Fixed predetermined phase shifts can for example be realized by means of different electrical lengths in a distribution network or by means of components that add a certain fixed electrical length.

According to some aspects, the sub-array antenna beam pointing direction settings S1, S2, S3, S4 are the same for the sub-array antenna ports 13, 14; 15, 16 of at least one set 2a, 2b, 2c, 2d, 2e, 2f, 2g, 2h of sub-array antennas 3a, 3b.

This means that the sub-array antenna beam pointing direction settings S1, S2, S3, S4 are the same for the sub-array antenna ports of least one array antenna column in the array antenna arrangement 1.

According to some aspects, the sub-array antenna beam pointing direction settings S1, S2, S3, S4 are mutually different for the sub-array antenna ports 13, 14; 15, 16 of at least one set 2a, 2b, 2c, 2d, 2e, 2f, 2g, 2h of sub-array antennas 3a, 3b.

This means that the sub-array antenna beam pointing direction settings S1, S2, S3, S4 are different for the sub-array antenna ports of least one array antenna column in the array antenna arrangement 1. As a consequence, one or more antenna columns can have sub-array antenna ports with the same sub-array antenna beam pointing direction settings S1, S2, S3, S4, and one or more other antenna columns can have antenna ports with mutually different sub-array antenna beam pointing direction settings S1, S2, S3, S4. It is also possible that all sub-array antenna ports of all array antenna column in the array antenna arrangement either have the same sub-array antenna beam pointing direction settings or mutually different sub-array antenna beam pointing direction settings.

According to some aspects, the digital antenna beam pointing direction settings S5, S6 are the same for those sets of radio chains 5a, 5b; 5c, 5d that are connected to the sub-array antenna ports 13, 14; 15, 16 of at least one set 2a, 2b, 2c, 2d, 2e, 2f, 2g, 2h of sub-array antennas 3a, 3b.

This means that the digital antenna beam pointing direction settings S5, S6 are the same for the sub-array antenna ports of least one array antenna column in the array antenna arrangement 1.

According to some aspects, the digital antenna beam pointing direction settings S5, S6 are mutually different for those sets of radio chains 5a, 5b; 5c, 5d that are connected to the sub-array antenna ports 13, 14; 15, 16 of at least one set 2a, 2b, 2c, 2d, 2e, 2f, 2g, 2h of sub-array antennas 3a, 3b.

This means that the digital antenna beam pointing direction settings S5, S6 are different for the sub-array antenna ports of least one array antenna column in the array antenna arrangement 1. As a consequence, one or more antenna columns can have sub-array antenna ports with the same digital antenna beam pointing direction settings S5, S6, and one or more other antenna columns can have antenna ports with mutually different digital antenna beam pointing direction settings S5, S6. It is also possible that all sub-array antenna ports of all array antenna column in the array antenna arrangement either have the same digital antenna beam pointing direction settings S5, S6 or mutually different digital antenna beam pointing direction settings S5, S6.

Generally, the present disclosure relates to an array antenna arrangement 1 comprising at least one set 2a, 2b, 2c, 2d, 2e, 2f, 2g, 2h of at least two sub-array antennas 3a, 3b. Each set 2a, 2b, 2c, 2d, 2e, 2f, 2g, 2h of sub-array antennas 3a, 3b is mounted such that a corresponding array antenna column is formed. For each polarization P1, P2 in each set 2a, 2b, 2c, 2d, 2e, 2f, 2g, 2h of sub-array antennas 3a, 3b each sub-array antenna 3a, 3b comprises a corresponding sub-array antenna port 13, 15; 14, 16 that is associated with a certain sub-array antenna beam pointing direction setting S1, S2, S3, S4, and each sub-array antenna port 13, 15; 14, 16 is connected to a corresponding radio chain 5a, 5c; 5b, 5d in a set of radio chains 5a, 5c; 5b, 5d. Each set of radio chains 5a, 5c; 5b, 5d is adapted to provide a corresponding digital antenna beam pointing direction setting S5, S6. In at least one set 2a, 2b, 2c, 2d, 2e, 2f, 2g, 2h of sub-array antennas 3a, 3b, at least one sub-array beam pointing direction setting S1, S3; S2, S4, differs from a corresponding digital antenna beam pointing direction setting S5, S6.

With reference to FIG. 6, the present disclosure also relates to a method for obtaining a desired beam pointing direction D1 for an array antenna arrangement 1 having at least one set 2a, 2b, 2c, 2d, 2e, 2f, 2g, 2h of at least two sub-array antennas 3a, 3b mounted such that a corresponding array antenna column is formed. For each polarization P1, P2 in each set 2; 2a, 2b, 2c, 2d, 2e, 2f, 2g, 2h of sub-array antennas 3a, 3b:
Each sub-array antenna 3a, 3b comprises a corresponding sub-array antenna port 13, 15; 14, 16 that is associated with a certain sub-array antenna beam pointing direction setting S1, S2, S3, S4.
Each sub-array antenna port 13, 15; 14, 16 is connected to a corresponding radio chain 5a, 5c; 5b, 5d in a set of radio chains 5a, 5c; 5b, 5d, where each set of radio chains 5a, 5c; 5b, 5d is adapted to provide a digital antenna beam pointing direction setting S5, S6.

The method comprises:
providing A10 a digital antenna beam pointing direction setting S5, S6 for each sub-array antenna port 13, 15; 14, 16; and
adjusting A20 sub-array beam pointing direction settings S1, S2, S3, S4 associated with corresponding sub-array antenna ports 13, 14, 15, 16 such that a desired vertical side lobe level is obtained for the array antenna arrangement 1.

According to some aspects, for at least one set 2a, 2b, 2c, 2d, 2e, 2f, 2g, 2h of sub-array antennas 3a, 3b, at least one sub-array beam pointing direction S1, S3, S2, S4 setting differs from the corresponding digital antenna beam pointing direction setting S5, S6.

According to some aspects, each sub-array antenna 3a, 3b has at least two sub sub-arrays 17, 18 using one or two common polarizations P1, P2, each sub sub-array 17, 18 using at least one antenna element 6a, 6b, 7a, 7b 8a, 8b; 9a, 9b, 10a, 10b, 11a; 11b.

According to some aspects, each sub-array antenna beam pointing direction setting S1, S2; S3, S4 is obtained by means of at least one controllable phase shifter 12a, 12b, 12c, 12d for each sub-array antenna port 13, 14; 15, 16.

According to some aspects, each sub-array antenna beam pointing direction setting S1, S2; S3, S4 is obtained by means of fixed predetermined phase shifts.

According to some aspects, the sub-array antenna beam pointing direction settings S1, S2, S3, S4 are the same for the sub-array antenna ports 13, 14; 15, 16 of at least one set 2a, 2b, 2c, 2d, 2e, 2f, 2g, 2h of sub-array antennas 3a, 3b.

According to some aspects, the sub-array antenna beam pointing direction settings S1, S2, S3, S4 are mutually different for the sub-array antenna ports 13, 14; 15, 16 of at least one set 2a, 2b, 2c, 2d, 2e, 2f, 2g, 2h of sub-array antennas 3a, 3b.

According to some aspects, the digital antenna beam pointing direction settings S5, S6 are the same for those sets of radio chains 5a, 5b; 5c, 5d that are connected to the sub-array antenna ports 13, 14; 15, 16 of at least one set 2a, 2b, 2c, 2d, 2e, 2f, 2g, 2h of sub-array antennas 3a, 3b.

According to some aspects, the digital antenna beam pointing direction settings S5, S6 are mutually different for those sets of radio chains 5a, 5b; 5c, 5d that are connected to the sub-array antenna ports 13, 14; 15, 16 of at least one set 2a, 2b, 2c, 2d, 2e, 2f, 2g, 2h of sub-array antennas 3a, 3b.

According to some aspects, the present disclosure relates to active antenna systems (AAS) consisting of array of sub-arrays where phase-shifters are added within the sub-arrays allowing for semi-static electrical tilt setting of the sub-arrays, for instance, consisting of electro-mechanical controlled phase shifters composed of movable parts accomplishing true-time delay phase shifting.

A semi-static tilt setting of the sub-arrays is combined with a digital tilt setting for the sub-array excitations and thereby giving the possibility to control, adjust and reconfigure the upper vertical side lobe levels by means of software control.

For a desired vertical beam pointing direction θ_{D}, the tilt setting for a sub-array can be somewhat larger than the desired vertical beam pointing direction θ_{D} while the digital tilt is set to the same value as the desired vertical beam pointing direction θ_{D}. By over-tilting the sub-arrays, the vertical pattern of the sub-arrays will suppress the first upper side lobe. The amount of over-tilting of the sub-arrays will determine the suppression of the first upper side lobe level. Thereby, the side lobe level can be controlled and reconfigured by the setting of sub-array tilt in combination with the digital tilt for proper pointing direction.

A possibility for side lobe level enhancements and reconfigurability is thus provided by means of software control in AAS products.

The present disclosure is not limited to the example above, but may vary freely within the scope of the appended claims. For example, the present disclosure is applicable for any suitable array antenna, not only AAS products.

1. An array antenna arrangement comprising at least one set of at least two sub-array antennas, where each set of sub-array antennas is mounted such that a corresponding array antenna column is formed, where, for each polarization in each set of sub-array antennas:
each sub-array antenna comprises a corresponding sub-array antenna port that is associated with a certain sub-array antenna beam pointing direction setting;
each sub-array antenna port is connected to a corresponding radio chain in a set of radio chains, where each set of radio chains is adapted to provide a corresponding digital antenna beam pointing direction setting; and
wherein, in at least one set of sub-array antennas, at least one sub-array beam pointing direction setting, differs from a corresponding digital antenna beam pointing direction setting.

2. The array antenna arrangement according to claim 1, wherein each sub-array antenna comprises at least two sub sub-arrays having one or two common polarizations, each sub sub-array comprising at least one antenna element.

3. The array antenna arrangement according to, claim 1, wherein each sub-array antenna beam pointing direction setting is obtained by means of at least one controllable phase shifter for each sub-array antenna port.

4. The array antenna arrangement according to claim 1, wherein each sub-array antenna beam pointing direction setting is obtained by means of fixed predetermined phase shifts.

5. The array antenna arrangement according to claim 1, wherein the sub-array antenna beam pointing direction settings are the same for the sub-array antenna ports of at least one set of sub-array antennas.

6. The array antenna arrangement according to, claim 1, wherein the sub-array antenna beam pointing direction settings are mutually different for the sub-array antenna ports of at least one set of sub-array antennas.

7. The array antenna arrangement according to claim 1, wherein the digital antenna beam pointing direction settings are the same for those sets of radio chains that are connected to the sub-array antenna ports of at least one set of sub-array antennas.

8. The array antenna arrangement according to claim 1, wherein the digital antenna beam pointing direction settings are mutually different for those sets of radio chains that are connected to the sub-array antenna ports of at least one set of sub-array antennas.

9. A method for obtaining a desired beam pointing direction for an array antenna arrangement having at least one set of at least two sub-array antennas mounted such that a corresponding array antenna column is formed, where, for each polarization in each set of sub-array antennas:
each sub-array antenna comprises a corresponding sub-array antenna port that is associated with a certain sub-array antenna beam pointing direction setting, and
each sub-array antenna port is connected to a corresponding radio chain in a set of radio chains, where each set of radio chains is adapted to provide a digital antenna beam pointing direction setting, wherein the method comprises:
providing a digital antenna beam pointing direction setting for each sub-array antenna port; and
adjusting sub-array beam pointing direction settings associated with corresponding sub-array antenna ports such that a desired vertical side lobe level is obtained for the array antenna arrangement.

10. The method according to claim 9, wherein, for at least one set of sub-array antennas, at least one sub-array beam pointing direction setting differs from the corresponding digital antenna beam pointing direction setting.

11. The method according to claim 9, wherein each sub-array antenna has at least two sub sub-arrays using one or two common polarizations, each sub sub-array using at least one antenna element.

12. The method according to claim 9, wherein each sub-array antenna beam pointing direction setting is obtained by means of at least one controllable phase shifter for each sub-array antenna port.

13. The method according to claim 9, wherein each sub-array antenna beam pointing direction setting is obtained by means of fixed predetermined phase shifts.

14. The method according to claim 9, wherein the sub-array antenna beam pointing direction settings are the same for the sub-array antenna ports of at least one set of sub-array antennas.

15. The method according to claim 9, wherein the sub-array antenna beam pointing direction settings are mutually different for the sub-array antenna ports of at least one set of sub-array antennas.

16. The method according to claim 9, wherein the digital antenna beam pointing direction settings are the same for those sets of radio chains that are connected to the sub-array antenna ports of at least one set of sub-array antennas.

17. The method according to claim 9, wherein the digital antenna beam pointing direction settings are mutually different for those sets of radio chains that are connected to the sub-array antenna ports of at least one set of sub-array antennas.
